(19) United States
(12) Patent Application Publication
(10) Pub. No.: US 2024/0320742 A1
(43) Pub. Date: Sep. 26, 2024

(54) NET FINANCIAL STATUS INDICATOR FOR GRAPHICAL FINANCIAL ANALYSIS

(71) Applicant: Wells Fargo Bank, N.A., San Francisco, CA (US)

(72) Inventors: Benjamin S. Taylor, Williston, VT (US); Allison Fine, Charlotte, NC (US)

(21) Appl. No.: 18/188,842

(22) Filed: Mar. 23, 2023

(51) Int. Cl. G06Q 40/06; G06Q 40/02

(52) U.S. Cl. CPC G06Q 40/06; G06Q 40/02

(57) ABSTRACT

Various examples are directed to systems and methods for interfacing a computing system to a user. A plurality of financial data is received by a financial services platform, including financial inflow data and financial outflow data for the user of the platform. A financial indicator score is calculated based on an algorithmic analysis of the inflow and outflow data. A financial indicator object is generated by the system, which causes a graphical user interface to be displayed to the user including the financial status indicator representing a pictogram of the financial indicator score. For example, a net-zero indicator can be displayed to the user to gamify the user's understanding of net-zero spending, progress, and achievements, and the system can generate financial services advice to help the user achieve net-zero.

### TECHNICAL FIELD

Embodiments described herein generally relate to systems, methods, and machine-readable medium for interfacing a computing device or system of computing devices to a human user. For example, embodiments described herein are directed to systems and methods for calculating, generating, and/or serving a user interface for displaying a financial status indicator infographic.

### BACKGROUND

User interfaces are used to display information on websites, mobile apps, and other applications. Interacting with banks can be cumbersome and daunting for users. As users navigate their lives, their interactions and banking needs often change based on various factors. In some cases, users feel frustrated when their financial information is not immediately understandable at a glance, and often users are unable to accurately identify and appreciate their financial status based on a pictogram or infographic.

Users should keep an accurate accounting of their available balances in their financial accounts. In the past, a user would manually keep track of any checks deposited and written and their current available balance until they clear so as to not bounce any checks. However, as online banking became the regular way in which users conducted their financial affairs, many users no longer kept physical track of their balances. Instead, the users rely on online banking applications and websites to determine their available balance and show any pending transactions.

### BRIEF DESCRIPTION OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. The drawings illustrate generally, by way of example, but not by way of limitation, various embodiments discussed in the present document. Various embodiments in accordance with the present disclosure will be described with reference to the drawings, in which:

FIG. 1 is an illustration of components of a financial institution server and a client device, according to various examples.

FIG. 2 is a diagram showing one example of an environment for interfacing between a computing device and a user to display a financial status indicator to the user.

FIG. 3 is a diagram showing another example of the environment of FIG. 2 including additional details.

FIG. 4 is a diagram showing example screens of a graphical user interface (GUI) in accordance with some embodiments.

FIG. 5 is a diagram showing example financial status indicators for display on the GUI in accordance with example embodiments.

FIG. 6 is a diagram showing example financial status indicators for display on the GUI in accordance with example embodiments.

FIG. 7 is a flowchart showing one example of a process flow for modifying the GUI to illustrate a financial status indicator to the user.

FIG. 8 is a flowchart showing one example of a process flow for modifying the GUI to indicate a status of the financial status indicator to the user.

FIG. 9 is a block diagram showing an example architecture of a user computing device.

FIG. 10 is a block diagram showing one example of a software architecture for a computing device.

FIG. 11 is a block diagram illustrating a computing device hardware architecture, within which a set or sequence of instructions can be executed to cause a machine to perform examples of any one of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter can be practiced without these specific details. In general, well-known instruction instances, protocols, structures, and techniques are not necessarily shown in detail. It will be evident to one skilled in the art, however, that the present subject matter may be practiced without these specific details.

### Overview

Example embodiments of the present disclosure are directed to systems, methods, and machine-readable mediums that include a financial system, such as a financial service or an online banking system, which includes a financial status indicator (e.g., a net-zero indicator, a net-positive indicator, and/or a net-negative indicator) configured to visually display an indicator of a user's spending versus returns within a period time to show whether the user's spending is at a “net zero” (e.g., all or selected user's spending within a time period is offset by profits from the user's investments and/or other returns). The online banking system can include a wide range of financial inflow, outflow, and comparison data to be utilized by the system to calculate a financial indicator score (e.g., a net-zero score, a net-positive score, and/or a net-negative score) and provide a financial status indicator (e.g., a net-zero indicator, a net-positive indicator, and/or a net-negative indicator) to help the user manage their finances in an effective, convenient, and swift visual manner.

As used throughout example embodiments of the present disclosure and for the purposes of this description, the phrase “financial status indicator” may be referred to as and used interchangeably throughout with the phrases “financial indication system,” “indication system,” “neutrality metric,” “neutral portfolio benchmark,” “net-zero goals,” “net-zero investment target,” “sustainable finance indicator,” “net-zero indicator,” or merely “an indicator.” For the purposes of this description, the term “net-zero” generally refers to a strategy of balancing out financial risks and financial rewards, such that the net result is effectively neutral. The term “net-positive” generally refers to a strategy of more than a baseline or more than zero financial rewards, and “net-negative” generally refers to a strategy of less than a baseline or less than zero financial risks. By calculating, balancing, serving, and displaying the net financial strategy to a user of a financial system, the user's financial consequences and incentives are graphically provided to the user in a manner that visually depicts a stable, neutral, negative, or positive financial outcome. Other types of indicators can include net-positive indicators, net-negative indicators, and the like.

Individuals in younger generations are becoming more conscious about their spending habits, and increasingly rely on social media (e.g., TikTok®, Facebook®, Instagram Reels®, etc.) for advice of all kinds. The problem with having these individuals get financial advice from social media is the information could be inaccurate, incomplete, or inadvisable for the specific individual. Behaviorally, the ways in which different categories of users prefer to engage with financial services may vary based on a plethora of user circumstances and/or user characteristics. However, conventional financial institutions generally fail to consider these circumstances and characteristics when implementing virtual, online, and/or technology-based financial services. For example, younger-aged users, disabled users, users in noisy environments, etc. prefer to rely on text-based or graphical-based services to receive financial advice, banking information, and the like.

Traditional approaches for tracking user finances include providing numeric values for all financial inputs, outputs, and changes to the user for review of details. For example, pre-existing solutions for displaying visual finance information include displaying charts, graphs, and/or alphanumeric combinations that describe the written details related to the user's financials. Such conventional systems fail to provide a near-instantaneous view of the user's overall financial status in a clear, concise, simple, and visual representation using infographics or pictograms. Conventional systems are insensitive to the current state of online banking in which users require quick and simplistic answers to their overall financial state in a near-instantaneous manner. In addition, existing financial measurement, analysis, and display mechanisms fail to consider or incorporate the vast amount of incorrect, inappropriate, or irresponsible financial advice easily viewable on social media platforms that provides users with false or inadequate financial advice.

Example embodiments of the present disclosure improve upon existing models and overcome such current technical challenges by providing a simplistic visual indicator to track, measure, compare, and analyze financial net-zero impact to a user of a financial system. The technical solution to the above problem is to provide a net-zero indicator to show whether a user's spending is offset by their investments and/or other returns. This technical solution advantageously uses metrics to help users monitor their spending and incentivize users to seek proper financial information when they see they have not achieved net-zero.

The methods and system described herein leverage the quick and entertaining aspects of social media influence and provide displays for fast and appropriate visual understanding of a user's financial status. Example embodiments further overcome existing failures in technology by providing swift access to appropriate and accurate financial advisory services based on the net-zero indicator. Thus, example embodiments of the present disclosure solve the technical problem by building a financial status indicator that is reliable, extensible, and composable, enabling real-time or near real-time tracking and understanding of user financial performance at the glance of an image.

Example embodiments include a visual net-zero indicator to display to a user when their financial status is at “net-zero” on a given day. For example, where the user spent $10 but made $10 dollars from one of their stock investments, the net-zero indicator would display the user being at net-zero for the day. Additionally, users can configure the system to personalize the indicator by, for example, changing the period of time and/or other components that go into determining whether the user is actually achieving “net-zero.” The amount made through investments or other returns may be automatically calculated as a post-tax amount based on information provided by the user.

In further example embodiments, a user without any investment accounts (e.g., stock investments) may only care about their weekly spending habits, as such, the user can configure the system to provide a net-zero for a specific time period (e.g., every week, every month, etc.) based on the user's spending and/or transactions and basic annual salary. The system can further use existing information provided by the user (e.g., a user's group, age, occupation, etc.), along with other information, such as inflation information derived or mined from internal and/or external sources to predict whether the user will still be able to achieve net-zero over future time frames. The system presents this information to the user in a visually simplistic infographic.

In addition, the system can generate (e.g., using machine learning, artificial intelligence, artificial general intelligence, combination heuristics, etc.) financial investment advice (e.g., talk to a financial advisor, be more aggressive with stock investments, etc.) that includes predictions to help the user achieve net-zero. Example embodiments of the system can detect the user's net-zero history and generate graphics (e.g., badges, trophies, milestone achievements, etc.) showing the user's progress, and also visuals that compare the user's progress with the user's friends, family, community (e.g., by age group, geographical location, occupation, etc.). Users with less positive graphics (e.g., a badge specifying that the user has missed net-zero for some number of consecutive periods or showing that the user is in the lower 50% of achieving net-zero) may be inclined to talk with a financial professional and will be provided with options to talk with one of the bank's financial advisors.

Example embodiments further enable younger or technology-savvy users to engage in native platforms (e.g., mobile banking applications) and consult with professional financial advisors using a financial status indicator to receive appropriate, correct, and proper financial information in a manner previously unavailable in online financial services. Thus, example embodiments of the present disclosure provide for improved understanding of the impact of a user's finances and financial decisions via a visually decisive and simplistic financial status indicator as part of the interface of an online financial service.

### Detailed Embodiments

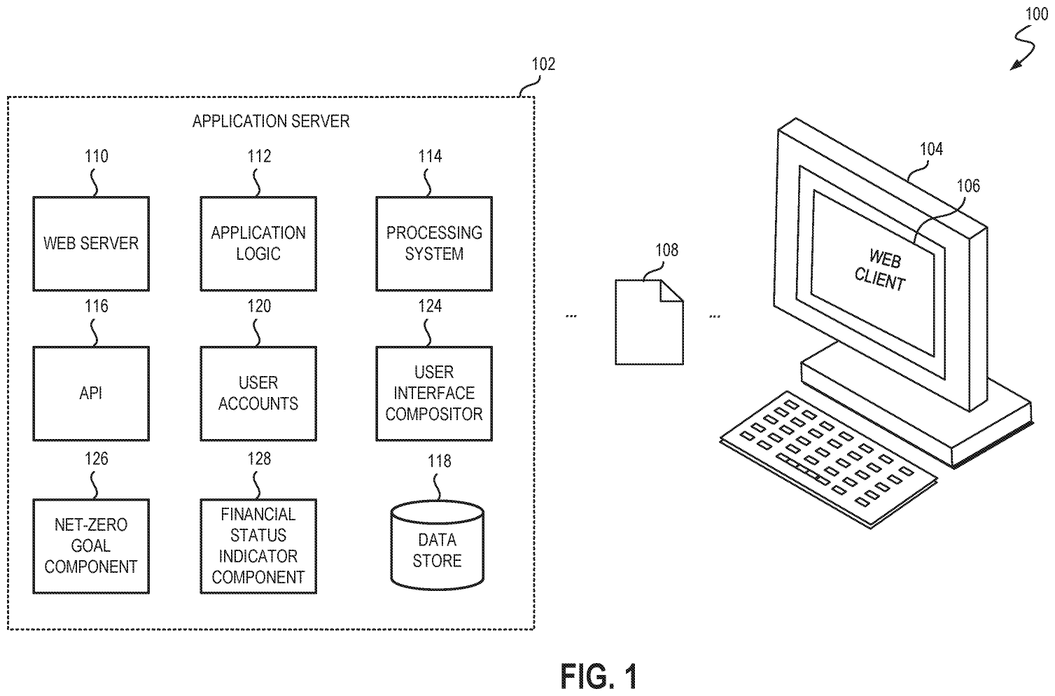

FIG. 1 is an illustration of a diagram 100 including components of an application server 102 and a client device 104 communicating transaction data 108, according to various examples. The diagram 100 includes the application server 102, the client device 104, a web client 106, a web server 110, application logic 112, a processing system 114, an application programming interface 116, a data store 118, user accounts 120, a user interface compositor 124, a net-zero goal component 126, and a financial status indicator component 128.

Application server 102 is illustrated as a set of separate elements (e.g., components, logic, etc.); however, the functionality of multiple, individual elements can be performed by a single element or multiple distinct application servers for the financial institution. An element can represent computer program code that is executable by processing system 114. The program code can be stored on a storage device (e.g., data store 118) and loaded into a memory of the processing system 114 for execution. Portions of the program code can be executed in parallel across multiple processing units (e.g., a core of a general-purpose computer processor, a graphical processing unit, an application specific integrated circuit, etc.) of the processing system 114. Execution of the code can be performed on a single device or distributed across multiple devices. In some example embodiments, the program code can be executed on a cloud platform (e.g., MICROSOFT AZURE®, AMAZON EC2®, etc.) using shared computing infrastructure.

Client device 104 can be a computing device which may be, but is not limited to, a smartphone, tablet, laptop, multi-processor system, microprocessor-based or programmable consumer electronics, game console, set-top box, or other devices that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, Global Positioning System (GPS) device, and the like.

Client device 104 and application server 102 can communicate the transaction data 108 via a network (not shown). Transaction data 108 can include, in various examples, user financial data, user selection data, graphics for display on client device 104, and/or other data used according to example embodiments. In some examples, the communication may occur using an Application Programming Interface (API), such as API 116. An API provides a method for computing processes to exchange data. A web-based API (e.g., API 116) can permit communications between two or more computing devices such as a client and a server. The API can define a set of HTTP calls according to Representational State Transfer (RESTful) practices. For example, A RESTful API can define various GET, PUT, POST, DELETE methods to create, replace, update, and delete data stored in a Database (e.g., data store 118). For example, application server 102 can implement an API call to create or edit an indicator, such as the financial status indicator component 128 (e.g., net-zero indicator, net-positive indicator, net-negative indicator, or other status indicator). The implementation of the financial status indicator component is discussed in more detail below.

Application server 102 can include web server 110 to enable data exchanges with client device 104 via web client 106. Although generally discussed in the context of delivering web pages via the Hypertext Transfer Protocol (HTTP), other network protocols may be utilized by web server 110 (e.g., File Transfer Protocol, Telnet, Secure Shell, etc.). A user can enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

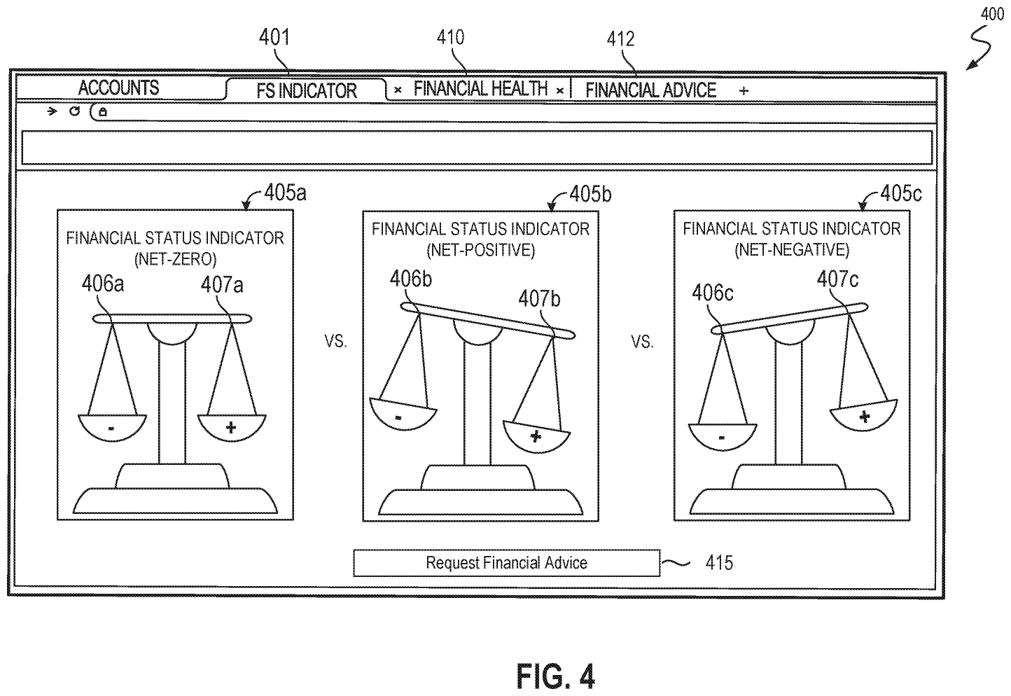

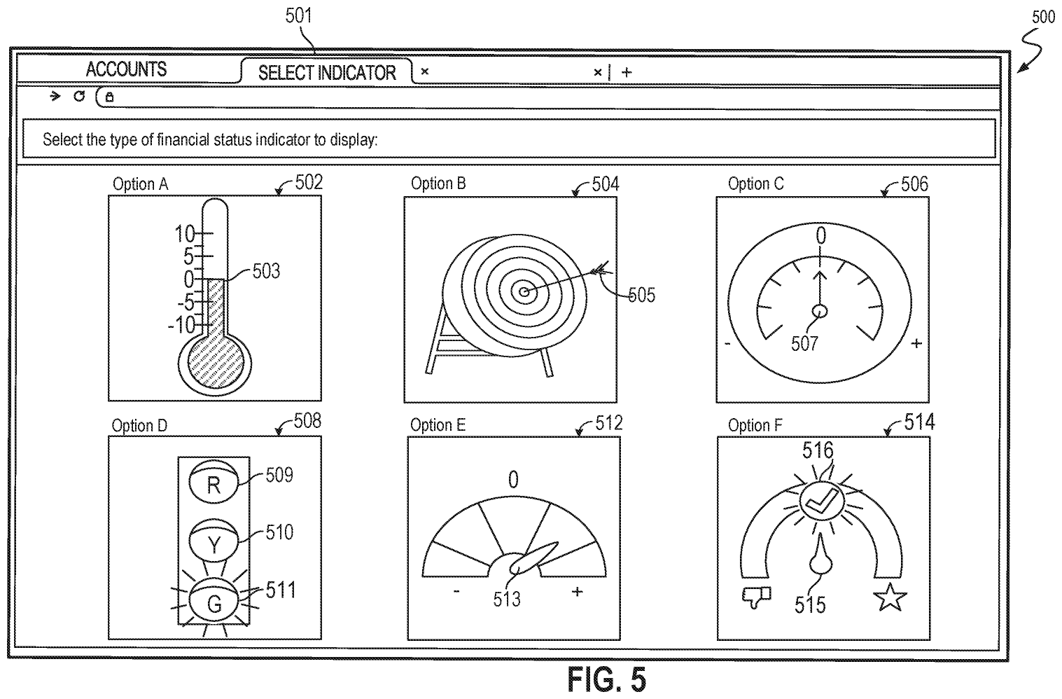

Additionally, web server 110 can enable the user to interact with one or more web applications provided in a transmitted web page. A web application can provide user interface (UI) or graphical user interface (GUI) components (as determined by user interface compositor 124) that are rendered on a display device of client device 104. The user can interact (e.g., select, move, enter text into) with the UI components, and based on the interaction, the web application may update one or more portions of the web page. A web application may be executed in whole, or in part, locally on client device 104. The web application can populate the UI components with data from external sources or internal sources (e.g., data store 118) in various examples. In example embodiments, the web application provides user interface elements to a user to create and view financial status indicators for fast and simplistic display. These aspects are discussed more in the context of FIG. 4 and FIG. 5.

The web application can be executed according to application logic 112. Application logic 112 can use the various elements of application server 102 to implement the web application. For example, application logic 112 can issue API calls to retrieve or store data from data store 118 and transmit it for display on client device 104, such as the net-zero indicator. Similarly, data entered by the user into a UI component can be transmitted using API 116 back to the web server 110. Application logic 112 can use other elements (e.g., user interface compositor 124, net-zero indicator component 128, etc.) of application server 102 to perform functionality associated with the web application as described further herein.

Data store 118 can store data that is used by application server 102. Data store 118 is depicted as a singular element but can in actuality be multiple data stores. The specific storage layout and model used in by data store 118 can take a number of forms—for example, a data store 118 can utilize multiple models. Data store 118 can be, but is not limited to, a relational database (e.g., SQL), non-relational database (NoSQL) a flat file database, object model, document details model, graph database, shared ledger (e.g., blockchain), or a file system hierarchy. Data store 118 can store data on one or more storage devices (e.g., a hard disk, random access memory (RAM), etc.). The storage devices can be in standalone arrays, part of one or more servers, and can be located in one or more geographic areas. For example, data store 118 can store net-zero indicator data structure, or other financial status indicators. A net-zero indicator data structure can include a user identifier, a total amount, a financial status amount, and an indicator identifier. Data structures can be implemented in several manners depending on a programming language of an application or database management system used by an application. For example, if C++ is used, the data structure may be implemented as a struct or class. In the context of a relational database, a data structure may be defined in a schema.

User accounts 120 can include user profiles on users of application server 102. A user profile can include credential information such as a username and hash of a password. A user can enter in their username and plaintext password to a login page of application server 102 to view their user profile information or interfaces presented by application server 102 in various examples. Different types of users can have different interfaces presented. A user account can also include preferences of the user. The preferences can include default preferences on if a financial status indicator should be displayed according to different time periods, can be displayed at various levels (e.g., always display the financial status indicator at $20 more than net-zero) etc. The financial institution can operate application server 102.

The net-zero goal component 126 can include logic to create a net-zero goal data structure. For example, a user interface can be presented to the user to enable the user to ask the system direct questions or locate pre-phrased questions related to the user's financial spending in a net-zero capacity. For example, the user can ask the system: “How are the things that I'm investing in socially impactful?” or “How are the things I'm being advised upon environmentally friendly?” or “How are the things that I'm being shown in terms of investment performance helping me reach net-zero in a responsible manner?”. The net-zero goal component 126 can further provide a user interface to be presented to the user with input capabilities to allow the user to provide net-zero goals (e.g., net-zero by four months, net-zero each week, net-zero in a socially responsible manner, etc.). After entry of the information related to the user's net-zero goals, the net-zero goal component 126 can generate a goal data structure based on the inputted information and save it to data store 118.

The net-zero goal component 126 can further update additional user accounts (e.g., a savings account, a checking account, etc.) of the user based on the created goal. For example, when a new net-zero goal is created, an update to the savings account can be made to a database that indicates the label of the created goal. Then when a user navigates to an overview of their savings account, the user can be able to see the current amount saved in the direction of the net-zero goal in a visual infographic representation. Example embodiments of visual infographics to display the financial status indicators are described and depicted in connection with FIGS. 4 and 5 herein.

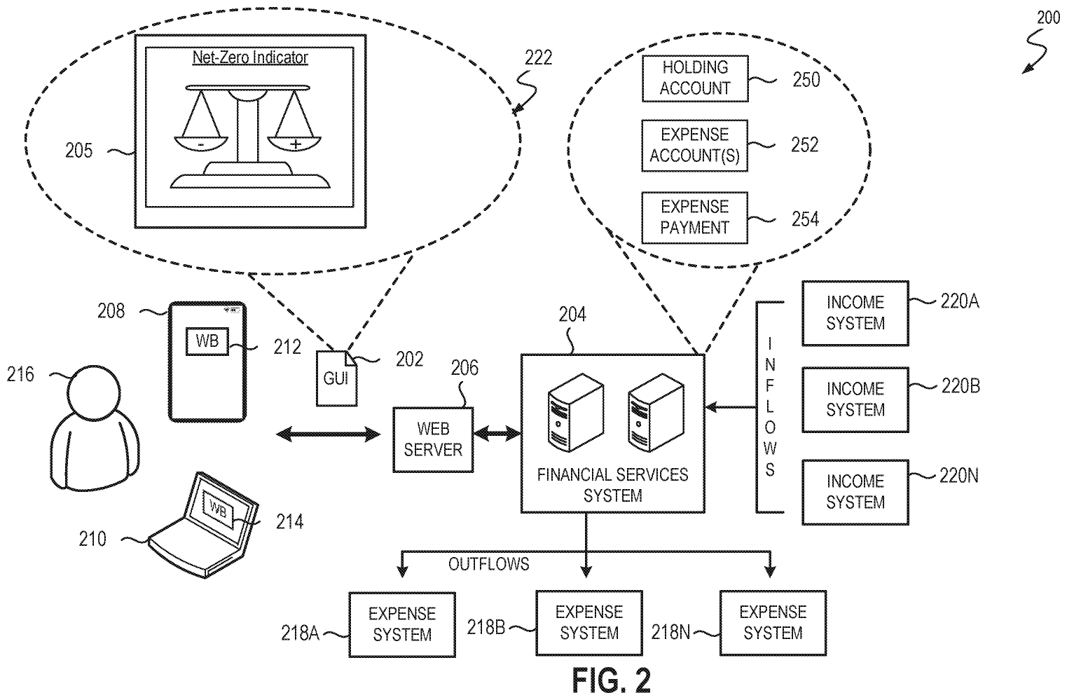

FIG. 2 is a diagram showing one example of an environment 200 for interfacing between a computing device and a user to provide a financial status indicator. The environment 200 includes a graphical user interface (GUI) 202 that is served to one or more user computing devices 208, 210 by a web server 206. The user computing devices 208, 210 may be any suitable computing device or devices such as, for example, a smart phone, a tablet computer, a laptop computer, a smart watch, etc. User computing devices 208, 210 can comprise a display for showing the GUI 202 to a user 216. In some examples, user computing devices 208, 210 execute a web browser application 212, 214. The web browser application 212, 214 may communicate with the web server 206 to receive the GUI 202 and display the GUI 202 at a screen or other display of the user computing device 208, 210. Although two user computing devices 208, 210 are shown in FIG. 2, in some examples, the user 216 receives the GUI 202 at a single user computing device (e.g., one of 208 or 210). In some examples, the user 216 receives the GUI 202 at different user computing devices 208, 210 at different times.

The environment 200 also includes a financial services system 204. The financial services system 204 includes one or more computing devices that may be at a common geographic location or may be distributed across multiple geographic applications. The financial services system 204 may receive data regarding one or more accounts held by the user 216, for example, as described herein. The GUI 202 may be generated by any suitable combination of the financial services system 204, the web server 206, and the user computing device 208, 210. Also, in some examples, the web server 206 is omitted and the user computing device 208, 210 is served the GUI 202 directly by the financial services system 204.

The financial services system 204 receives descriptions of one or more deposits to an account of the user 216 from one or more income systems 220A, 220B, 220N. Income systems 220A-220N may represent sources of income to the user 216 such as, for example, a bank system, payroll system, or other system associated with a company for which the user 216 is an independent contractor; a bank system, payroll system, or other system associated with a customer of the user 216, etc.

In some examples, the financial services system 204 also provides and/or requests expense payments to one or more expense systems 218A, 218B, 218N. Expense systems 218A, 218B, 218N can include any systems associated with an expense. For example, an expense system 218A, 218B, 218N can include a bank system associated with an account for the user 216 where the user 216 can save money for meeting an expense. An expense system 218A, 218B, 218N can include a system through which payments on the expense are made. For example, an expense system 218A, 218B, 218N associated with the Internal Revenue Service can receive expense payments associated with federal taxes. An expense system 218A, 218B, 218N associated with an insurance company can receive expense payments associated with automobile, homeowners, or other relevant insurance.

The financial services system 204 receives data regarding one or more accounts 250 and 252 held by the user 216. Accounts 250 and 252 can be any suitable type of financial account such as, for example, demand deposit accounts, savings accounts, etc. Accounts 250 and 252 can be used to hold funds received by deposit from one or more of the income systems 220A, 220B, 220N. A holding account 250 can receive deposited funds. In some examples, portions of the holding account 250 are allocated to cover certain expenses. The holding account 250, the expense account(s) 252, and the expense payments 254 can be used as input to determine, calculate, analyze, and generate the financial status indicator.

FIG. 2 further depicts an example screen 222 from the GUI 202. The screen 222 shows a net-zero indicator 205. The net-zero indicator 205 provides a quickly and easily understood graphical representation of the financial equilibrium of the user 216. The net-zero indicator 205 provides a quick general guideline to visually display a user how their finances (e.g., investment performance) is related to the movement (e.g., trending) of the user's financial flows. The finances of the user can be trending up, down, or neutral (e.g., net-zero) depending on whether the finances are increasing or decreasing during any given period. For example, the user's fiscal interests can be said to be “trending up” if they are consistently increasing over a period of time, “trending down” if they are consistently decreasing over a period of time, or “net-zero” if they are consistently equal over a period of time. The user's financial performance can include net inflows and outflows of some, any, or all of the user's fiscal interests or any other financial changes on a periodic or aperiodic basis (e.g., hourly, daily, monthly, quarterly, per pay period, etc.).

The net-zero indicator 205 provides the user with an indicator that includes a visual representation of a period of time that the user is interested in viewing and/or understanding, where the visual infographic enables the user to view what they have been spending offset by the performance of their investments, interests, income, and the like. For example, the infographic can be a pictogram of scales displaying the scales as level if the user is at net-zero (e.g., if their spending is “made-up” in terms of investment performance and allocations). Additional examples of types of indicators, such as financial status indicators (e.g., net-zero indicator, net-positive indicator, net-negative indicator, or other financial indicators) are described and depicted in further detail with reference to FIGS. 4, 5, and 6.

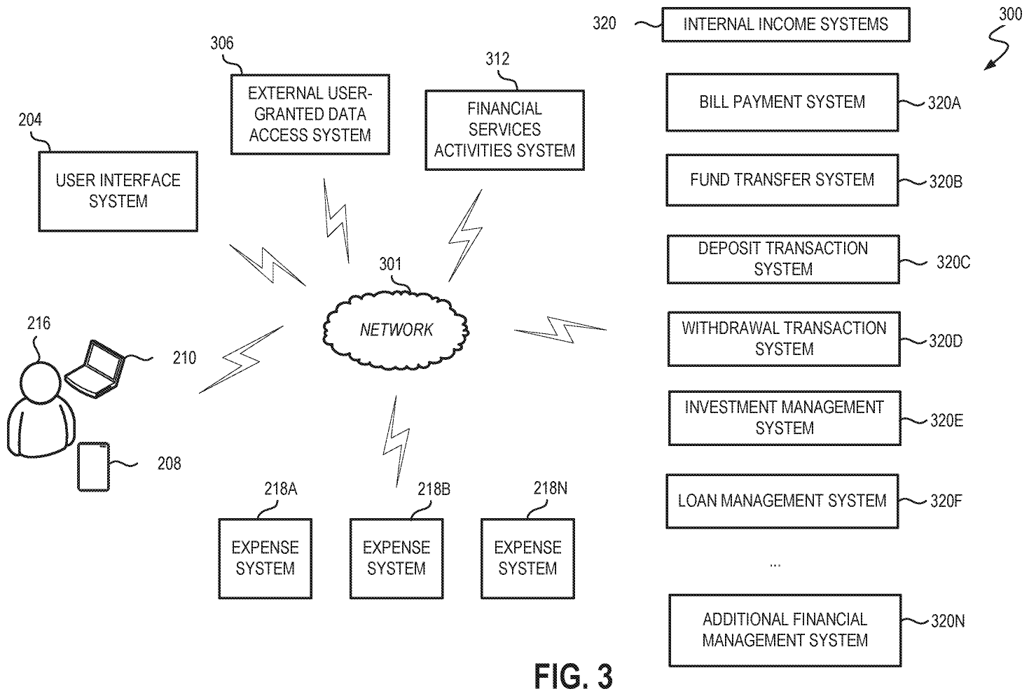

FIG. 3 is a diagram showing an environment 300 for interfacing between a computing device including additional details, according to example embodiments. In some examples, the environment 300 can include the same computing environment as the environment 200 depicted and described in connection with FIG. 2. FIG. 3 is similar in many respects to FIG. 2, sharing certain similar features and components; for brevity, only specific elements are detailed and described with reference to FIG. 2. To avoid obscuring the inventive subject matter with unnecessary detail, various functional components that are not germane to conveying an understanding of the inventive subject matter have been omitted from FIG. 3. However, a skilled artisan will readily recognize that various additional functional components may be included as part of the environment 300 to facilitate additional functionality that is not specifically described herein. In other embodiments, the environment can comprise another type of network-based database system or a financial platform.

In the example of FIG. 3, the user computing devices 208, 210, the user interface system 204, the expense systems 218A, 218B, 218N, and the income system 220A, 220B, 220N are in communication with one another via a network 301. The network 301 can be or comprise any suitable network element operated according to any suitable network protocol. The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet. For example, one or more portions of the network 301 can be an ad hoc network, an intranet, an extranet, a virtual private network (VPN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks, etc.

There are several types of financial inputs that are used by the online banking system. The financial services system 204 can further be connected with an external user-granted data access system 306 and internal income systems 320. The internal income systems 320 can include a bill payment system 320A, fund transfer system 320B, deposit transaction system 320C, withdrawal transaction system 320D, investment management system 320E, loan management system 320F, and/or additional financial management systems 320N. The internal income systems 320 can include all or a select group of systems directly associated with the financial services system 204 through which the user maintains financial accounts.

The bill payment system 320A can include an online banking system, such as the financial services system 204, that enables the user to make bill payments to merchants, service providers, payees, and the like. The fund transfer system 320B can use the online banking system to transfer funds between the user's own accounts or to send money to external businesses or individuals. The deposit transaction system 320C can allow the user to deposit funds from their accounts. The withdrawal transaction system 320D can allow the user to withdraw funds from their accounts. The investment management system 320E can provide investment management tools to the user. The loan management system 320F can enable the user to apply for loans or credit through the online banking system, such as for auto loans, mortgages, and the like. The additional financial management system 320N can provide additional financial services. The internal income systems 320 or any direct accounts that the financial services system has with the user (e.g., checking, saving, mortgage, investments, etc.), can be used in calculating and/or generating the financial status indicator (e.g., net-zero indicator, net-positive indicator, net-negative indicator, etc.). The different financial management systems can further be used, according to example embodiments, to recalculate the financial indicator score based on user financial inflow data, user financial outflow data, and financial services activities associated with the inflow data, outflow data, or other relevant user data from internal and/or external sources.

The example embodiment of FIG. 3 further depicts a financial services activities system 312 that is operably connected to the user 216 via the network 301. The financial services activities system 312 can be a component of the financial services system 204 or operably interconnected therewith. The financial services activities system 312 can include data derived or generated by the financial services system 204 or macro-economic activities related to research and guidance as to which way experts believe the market is going and how market direction is going to impact the economy, and the user. The financial services activities system 312 enables additional information to be generated by external sources and provided to or imported by the financial services system. The information could be from the same or different source as financial advisors use to focus on the financial indicators.

The external user-granted data access system 306 enables the user to provide or permit access to one or more external sources of financial or other personal information relating to the user. Additionally, external user-granted data access system 306 can get the user to tie in external accounts that are not specific to the financial services system (e.g., external banks, external credit card companies, etc.). For example, if the user grants the financial services system access to external data, such as if the user links their social media account to the financial services system, the financial services system can use social media posts to identify types of indicators that are relevant to the user at any given time. For example, the user may post that they are buying a new house or searching for new homes, so the financial services system could provide suggestions related to mortgages).

In additional example embodiments, a series of options can be presented to the user to select what is relevant to the user (e.g., during a specific time period, types of relevant inflow finance data sources, types of relevant outflow finance data sources, etc.). If something is missing from the series of options presented, the user can add in data sources, whether internal or external to the financial services system, which are relevant to the user. For example, the user can add in a geographically specific example, such as when general market performance is down, but the user is only interested in investing in oil stocks, which would otherwise be contrary to what the broader market is doing at that time.

Such optionality enables the system not to necessarily project a negative view of the future for that user because that user is interested in a specific use of stock. In some example embodiments, the system can provide an input box that allows the user to input any interests, and the financial services system can consider the inputted interests in the financial status indicator calculation. In further example embodiments, the user can have cross-platform access provided to the financial services system, so the financial services system can receive data that the user is interested in cryptocurrency on social media and include that interest in the financial status indicator analysis and calculations.

In additional example embodiments, the financial services system can determine, based on financial impacts for the user, what types of indicators to show to the user. For example, if the user does not have a mortgage, or has a fixed mortgage, the current financial worries related to changing mortgage rates may not be worrisome to the user. So, the user can select or change, and the financial services system can calculate the likelihood of that particular indicator being relevant to the user, so the display of that indicator, or use of that information in calculating the net-zero status is not rated as heavily. Such determinations can be made on a periodic basis, aperiodic basis, and/or changed based on user-provided information.

The financial services system can present the indicators that are driving the financial services system algorithm in calculating the financial status indicator for the user and provide the user varying levels of control over deciding how much each variable actually influences or impacts the user, and/or how much does the user want that variable to reflect into the user's net-zero score (e.g., for future projections).

In additional example embodiments, the financial status indicator or multiple indicators for distinctive features can be generated based on different types of users and different types of user interests. For example, a first user may have no interest in customization and the financial services system 204 can provide the first user with a standardized financial status indicator based on all available functionality, input, and data. A second user may have a medium interest in tailoring the financial status indicator to display specific interests, so the financial services system 204 can provide the second user with a semi-customizable financial status indicator. A third user may have a detailed knowledge of finances and market variabilities, so the financial services system 204 can provide a fully customizable financial status indicator to the third user, enabling the user to change any aspect of the one or more financial status indicators provided to the user.

FIG. 4 is a diagram showing an example financial status indicator screen 401 of a GUI 400. For example, the web server 206 as described and depicted in connection with FIG. 2 can serve the screen 401 to the user computing device 208, 210 to indicate a financial status indicator to the user. In the example embodiment of FIG. 4, the screen 401 includes three sample versions of the financial status indicator. The financial status indicator is a basic gauge that the user can view quickly without the need for additional information, reading of charts or numbers, associated detail, or the like.

The first version of the financial status indicator is a net-zero indicator 405a depicts an infographic of a negative scale 406a and a positive scale 407a, where the net-zero indicator 405a is shown with an equal or balanced level of the scales. The net-zero indicator 405a depicts a quick, reliable, and simplistic image to express to the user that the user's finances are balanced (e.g., there is an equal amount of inflow and outflow of finances such that the user's account is at equilibrium or net-zero).

The second version of the financial status indicator is a net-positive indicator 405b depicting the same infographic of a negative scale 406b and a positive scale 407b for when the financial status indicator is displayed in a net positive position. In the net-positive indicator 405b, the positive scale 407b is depicted as being “heavier” than the negative scale 406b. This infographic indicates that the user's finances are currently (e.g., for the specified or selected time period) greater than net-zero (e.g., the user has more inflow of finances than outflow of finances).

The third version of the financial status indicator is a net-negative indicator 405c depicting the same infographic of a negative scale 406c and a positive scale 407c for when the financial status indicator is displayed in a net negative position. In the net-negative indicator 405c, the negative scale 406c is depicted as being “heavier” than the positive scale 407c. This version of the financial status indicator infographic indicates that the user's finances are currently less than net-zero (e.g., the user has more outflow of finances than inflow of finances).

In example embodiments of the present disclosure, a user's financial health information 410 is used by the system to calculate the user's inflow and outflow of monies to determine the status of the financial status indicator. For example, the user's financial health information can include known and/or estimated financial inflow, such as salary, bonuses, investments, alimony, child support, welfare, unemployment, retirement, pension, social security, disability, settlements, and/or any additional source of income. The user's financial health information can further include expenses that are known and/or estimated financial outflow. For example, the user's expenses can include rent/mortgage, food, utilities, hygiene, repairs, debt repayments, insurances, taxes, entertainment, and/or any additional types of financial payments owed. The user's financial health information can further include assets (e.g., stocks, 401K, bonds, cryptocurrencies, etc.) and liabilities (e.g., mortgage, loans, credit cards, judgments, etc.).

Example embodiments receive or access the user's financial health information 410 to determine the difference between the user's financial inflow and the user's financial outflow. Based on the determined difference, an image of the financial status indicator (e.g., either one of the net-zero indicator 405a at equilibrium, the net-positive indicator 405b at net positive, or the net-negative indicator 405c at net negative) is created or generated by the display of a digital graphical representation of the visual financial information into an easy-to-understand infographic. In some example embodiments, the user's financial health information can be used to calculate the user's financial status indicator on a pre-tax or after-tax basis. For example, the system does not simply use $5,000 worth of financial gains based on the user's financial inflow, but automatically discounts or calculates the exact known or approximated estimate of current tax status amount (e.g., tax bracket, last known tax payment, etc.) from the financial gain.

Additional example embodiments can include multiple indicators, such as indicators for inflows, outflows, investment performance, and the like to provide a visual representation of the relationship between the financial types based on a glance of an infographic. For example, based on existing user behaviors (e.g., inflation status, mortgage rates, spending, etc.), what can the user visualize in order to help the user watch their day-to-day spending based on these trends. The financial status indicator or visual representation indicators can also provide examples for the user in which the user can add, change, and/or adjust their spending habits in order to provide the user with additional information related to their finances. For example, non-regular payments (e.g., seasonal worker, secondary-job work, side-business, etc.) can provide interesting usage patterns that can be swiftly reviewed by the user by viewing the infographic.

According to the example embodiment of FIG. 4, if the system calculates a net-zero score that is neutral or positive (e.g., a visual representation of equilibrium like 405a or net positive like 405b), then the user can simply understand that they do not need to act currently or urgently. However, if the financial status indicator provides a visual representation of trending (e.g., trending in the user's spending) in the wrong direction (e.g., a visual representation of net negative like net-zero indicator 405c), the financial services system provides a button for the user to select in order to provide next steps by selecting an option to request financial advice 415. Upon selection, the user can be provided with a recommendation of one or more financial advisory services. For example, financial advisory services can include linking the user with an advisor, displaying to the user what is being calculated by the net-zero indicator so the user can confirm or disaffirm the projections based on the information that is being calculated to provide those projections, providing the user with Frequently Asked Questions, connecting the user with an artificial intelligence program related to financial advice, or other financial services options.

In some example embodiments, the user can select the option to request financial advice 415 based on the quick review of the financial status indicator displayed to the user, which provides the user with automated, personalized, and/or machine-learning generated financial advice. In some example embodiments, if the user does not select to request financial advice 415, the system can transmit a text-interaction (e.g., automated bot) or an in-application messaged based on an algorithm that informs the user of ways to learn more about the next-best financial recommendation.

The system can provide the user with a series of hand-offs that are increasingly interactive providing more detailed financial information and advice depending on the user's interaction with the system. For example, the system can alert the user that something changed in their net-zero score via a text-based warning in the financial services system application or sent to the user's phone with a text, “something changed in your net-zero score, do you want to know more? Press 1 for yes.” The system can further include intermediary steps that are prompts and questions, interactive text with a bot, provide information related to what types of advisors are available to speak with (e.g., the financial services system can have a stratified level of financial professionals, such as a customer coach, a customer relationship, a customer advisor, DIY-type tools for managing investments, personal banker, private banker, etc.).

The financial services system 204 can further provide a financial advice service 412 for supporting the user with additional levels of financial insight and guidance in making recommendations for the user based on the user's current situation. For example, the financial advice service 412 can incentivize the user to get financial information from the financial services system and not social media applications, random Internet articles, or other inexperienced sources. The financial advice service 412 can identify reliable sources of financial information and/or help the user understand social media or non-professional sources of financial advice.

The financial advice service 412 can further help the user understand information or advice found by the user on social media platforms. For example, it can help the user determine if (1) what is being described is technically correct and (2) what is described is applicable to the user's specific situation (e.g., reverse mortgages may be described appropriately in a video, but that specific user would be advised against a reverse mortgage based on their specific inflows and outflows).

In additional example embodiments, if the user decides to start speculating on a financial topic or opportunity, the financial status indicator provides a signal that such a speculation would be potentially harmful for their net-zero score. For example, if the financial services system can identify that the user has been net-positive, the financial status indicator can have a current-term or future-term presentation to the user depending on what information sources (e.g., social media) the user is providing.

In additional example embodiments, when the user is consistently net-positive for X months, indicating a positive financial journey, the indicator can provide information to suggest additional capabilities or services the user should be considering from the financial service (e.g., suggest adding money into IRA, college funds, etc.). The indicator can then suggest more sophisticated capabilities for their financial situation.

FIG. 5 is an example graphical user interface (GUI) 500 providing different example financial status indicators for the user to select. For example, the web server 206 as described and depicted in connection with FIG. 2 can serve the screen 501 to the user computing device 208, 210 to indicate a selection of financial status indicators to the user.

In the example embodiment of FIG. 5, the screen 501 includes six different examples of an indicator infographic or symbol for the user to choose from. Option A 502 depicts a thermometer with an indicator 503 depicting net zero. Option B 504 depicts a bullseye target with an arrow 505 at the center of the bullseye depicting net zero. Option C 506 depicts a gauge with an arrow 507 pointing to “0” depicting net zero. Option D 508 is a traffic light with a red light 509, a yellow light 510, and an illuminated green light 511 depicting net zero. Option E 512 is a different style gauge with an arrow 513 depicting net positive. Option F 514 is a pictogram gauge with an arrow 515 pointing to an illuminated check mark 516 depicting net zero.

The indicator can represent an overall net financial status (e.g., net-zero indicator, net-positive indicator, or net-negative indicator) or a status class of the user. For example, the indicator can include a passive indicator and/or an active indicator. The user can select settings related to which type of indicator the user prefers.

The passive indicator can include the user interface of the financial services system application changing based on a net-zero status. For example, if there are three statuses for indication of financial status (1) good, (2) warning, and (3) bad, or (1) positive, (2) neutral, and (3) negative. Wherein each overall net financial status or status class has a different visual representation on the user interface. For example, for the good or positive status class, the colors of the background of the GUI are set to green, the font is set to a visually pleasing font, and the username is set with a green border. For the warning or neutral status class, the colors of the background of the GUI are set to yellow, the font is set to a visually harsher font, and the username is set with a yellow border. For the bad or negative status class, the background colors of the GUI are set to red, the font is set to a visually alarming font, and the username is set with a red border.

According to some example embodiments, in response to a change in overall financial status (e.g., from a net-zero indicator to a net-positive indicator), the system can automatically or dynamically adjust the graphical user interface styles, stylesheets, or other visual attributes of the GUI. For example, system can dynamically adjust the font of the text (e.g., style, typeface, size, etc.), the color of the text, background, and/or elements, the thickness, style, and/or color of the borders, the amount of spacing between the content of an element and borders, the amount of spacing between an element and the surrounding container, and the like.

As would be understood by those having ordinary skill in the art, such colors and fonts are just exemplary for purposes of explanation and any visual GUI changes could be set for the statuses to provide a visual representation of change in status. In some example embodiments, the entire user interface, in addition to the financial status indicator infographic, can visually change to provoke visual cues and/or emotions in the user depending on the calculated net-zero score. For example, the GUI can include hues of colors (e.g., slightly darker green, slightly lighter red, etc.) depending on the gravity of the net-zero score in a positive or negative direction.

In alternative example embodiments, the financial status indicator can be an active indicator. The active indicator can include an icon or graphic (e.g., badge(s), thermostat, bubble, numbers, shapes, etc.) that is placed on the graphical user interface of the financial services system application. The user can choose from a selection of different graphical indicator representations that can be displayed on the user's graphical user interface. Each financial status indicator can be displayed using colors, patterns, fills, numbers, letters, designs, or the like to indicate the status class.

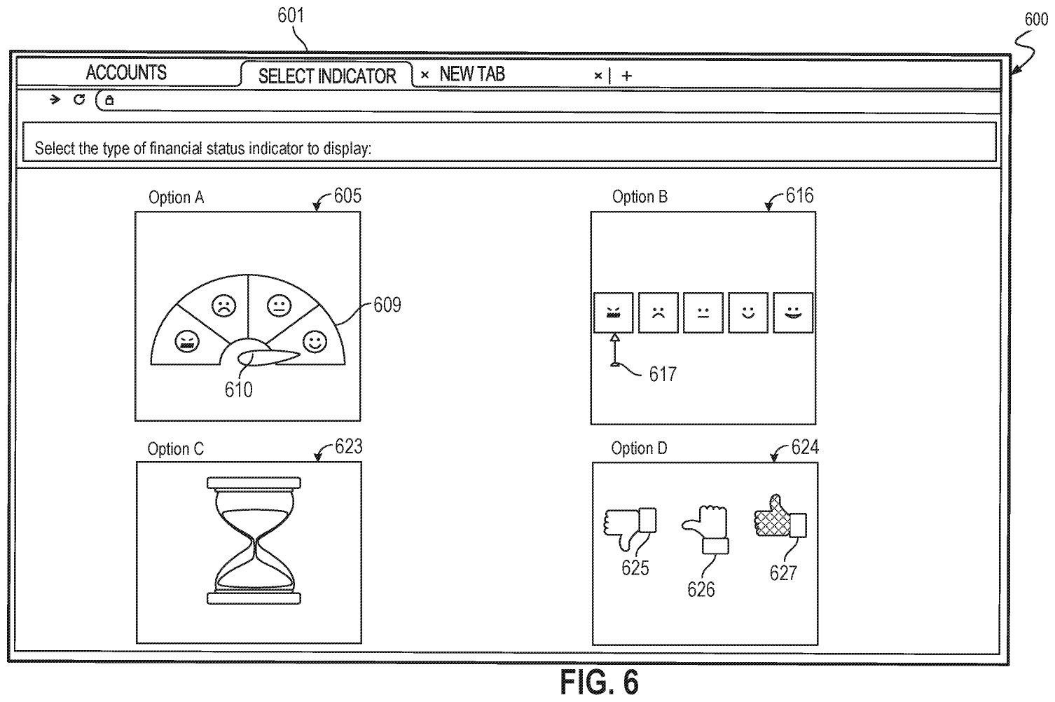

FIG. 6 is an example graphical user interface (GUI) 600 providing additional example indicators for the user to select similarly to that of FIG. 5.

In the example embodiment of FIG. 6, the screen 601 includes four different examples of an indicator infographic or symbol for the user to choose from. Option A 605 depicts a gauge with a variety of emojis illustrating different emotions with an arrow 610 pointing to a smiling emoji 609 depicting a net positive indicator. Option B 616 depicts a variety of emojis illustrating different emotions with an arrow 617 pointing to an angry face emoji depicting a net negative indicator. Option C 623 depicts an hourglass with half of the sand in the top and half of the sand in the bottom depicting a net zero indicator. Option D 624 depicts a thumbs-down icon 625, a neutral thumb icon 626, and a highlighted thumbs-up icon 627 depicting a net positive indicator

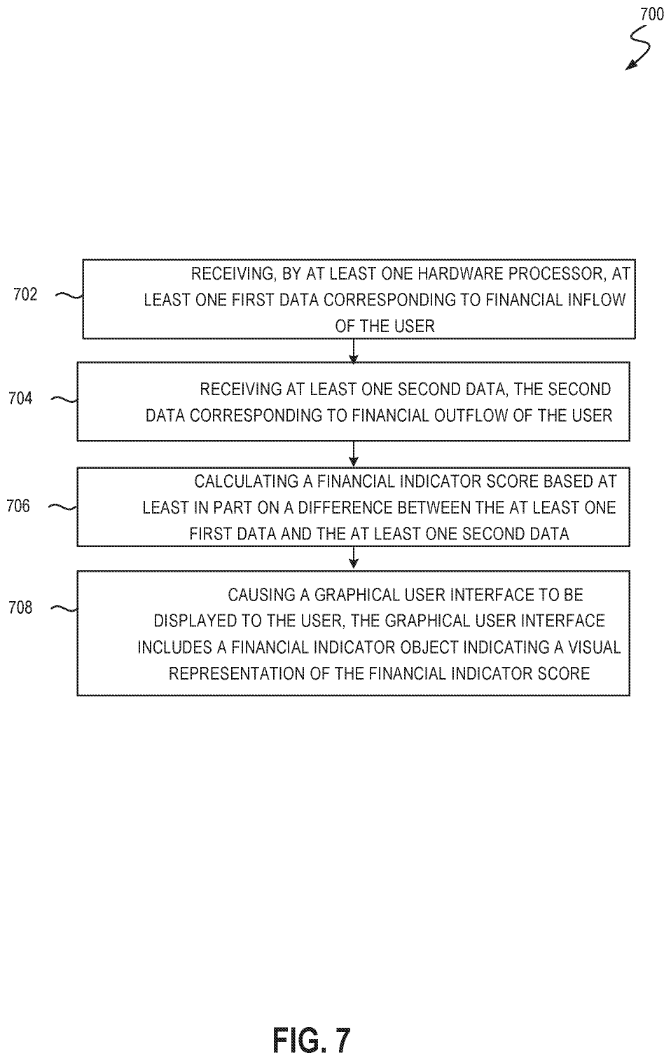

FIG. 7 is a flowchart showing one example of a process flow for modifying the graphical user interface (GUI) to indicate a financial status indicator, according to some example embodiments.

The process flow 700 is described as being performed by the financial services system 204, although in some examples some or all of the process flow 700 is executed by the web server 206 and/or the user computing devices 208, 210. At operation 702, the financial services system 204 receives, from at least one hardware processor, at least one first data corresponding to financial inflow of the user. At operation 704, the financial services system 204 receives at least one second data corresponding to financial outflow of the user. At operation 706, the financial services system 204 calculates a financial indicator score based at least in part on a difference between the first data and the second data. At operation 708, the financial services system 204 causes a graphical user interface to be displayed to the user, where the GUI includes a financial indicator object indicating a visual representation of the financial indicator score.

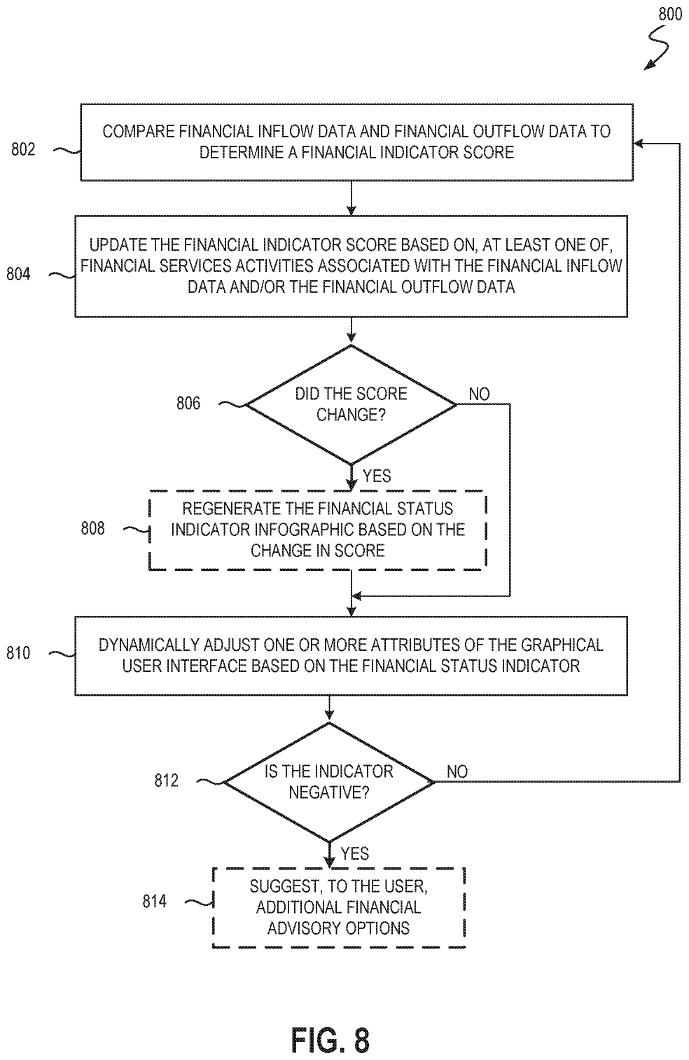

FIG. 8 is a flowchart showing one example of a process 800 for modifying the graphical user interface (GUI) to incorporate different styles based on the financial status indicator, according to some example embodiments.

The process 800 is described as being performed by the financial services system 204, although in some examples some or all of the process 800 is executed by the web server 206 and/or the user computing devices 208, 210. At operation 802, the financial services system 204 compares financial inflow data of the user and financial outflow data of the user to determine a financial indicator score. For example, the financial services system 204 can use one or more mathematical or algorithmic operations to calculate the financial indicator score based on the user's income systems and expense systems.

At operation 804, the financial services system 204 updates the financial indicator score based on at least one of financial services activities associated with the financial inflow data and/or financial services activities associated with the financial outflow data. At operation 806, the financial services system 204 determines if the financial indicator score changed based on the financial services activities. If yes, then, at optional operation 808, the financial services system 204 regenerates, updates, or changes the financial status indicator infographic (e.g., the net-zero indicator, net-positive indicator, net-negative indicator, etc.).

If optional operation 808 is omitted, after operation 804, and/or if the financial services system 204 determines no, the score did not change, the financial services system 204 can, at operation 810, dynamically adjust one or more attributes of the graphical user interface based on the financial status indicator. For example, the system can modify, vary, or adapt one or more style properties of the GUI design to accentuate the GUI in conformity with the financial status indicator.

At operation 812, the financial services system 204 determines if the financial status indicator is negative (e.g., a net-negative indicator). If yes, then, at optional operation 814, the financial services system 204 suggests to the user additional financial advisory options the user can pursue in order to change their financial status indicator in a more positive direction. If the financial services system 204 determines the financial status indicator is not negative, the process 800 can return to operation 802 for continuous, periodic, or at-will monitoring.

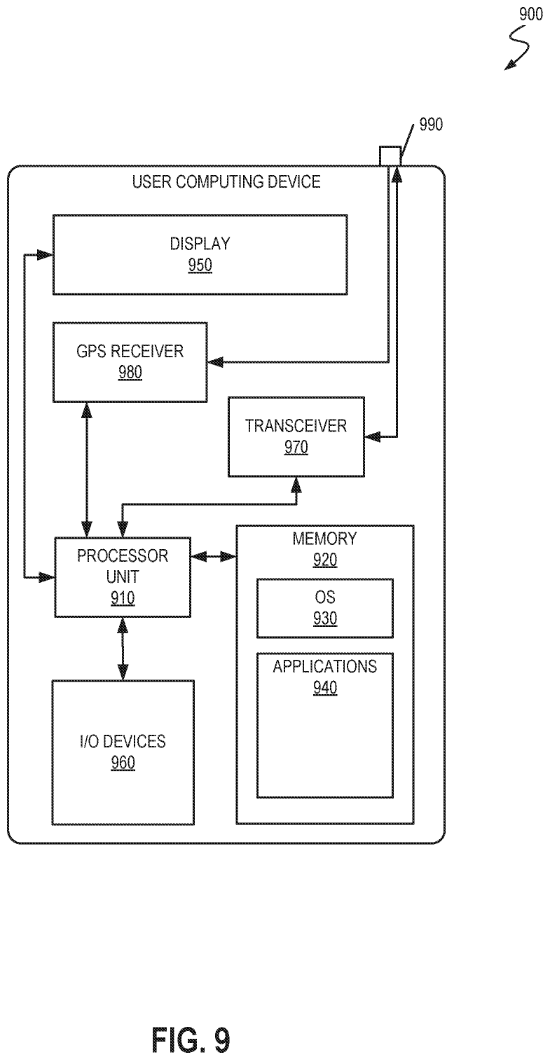

FIG. 9 is a block diagram showing an example architecture 900 of a user computing device. The architecture 900 may, for example, describe any of the computing devices described herein, including, for example, the user computing devices 208, 210, the web server 206, the financial services system 204, expense systems 218A, 218B, 218N, income systems 220A, 220B, 220N, etc. The architecture 900 comprises a processor unit 910. The processor unit 910 may include one or more processors. Any of a variety of different types of commercially available processors suitable for computing devices may be used (for example, an XScale architecture microprocessor, a Microprocessor without Interlocked Pipeline Stages (MIPS) architecture processor, or another type of processor). A memory 920, such as a Random Access Memory (RAM), a flash memory, or another type of memory or data storage, is typically accessible to the processor unit 910. The memory 920 may be adapted to store an operating system (OS) 930, as well as application programs 940.

The processor unit 910 may be coupled, either directly or via appropriate intermediary hardware, to a display 950 and to one or more input/output (I/O) devices 960, such as a keypad, a touch panel sensor, a microphone, and the like. Such I/O devices 960 may include a touch sensor for capturing fingerprint data, a camera for capturing one or more images of the user, a retina scanner, or any other suitable devices. The I/O devices 960 may be used to implement I/O channels, as described herein. In some examples, the I/O devices 960 may also include sensors.

Similarly, in some examples, the processor unit 910 may be coupled to a transceiver 970 that interfaces with an antenna 990. The transceiver 970 may be configured to both transmit and receive cellular network signals, wireless data signals, or other types of signals via the antenna 990, depending on the nature of the computing device implemented by the architecture 900. Although one transceiver 970 is shown, in some examples, the architecture 900 includes additional transceivers. For example, a wireless transceiver may be utilized to communicate according to an IEEE 802.11 specification, such as Wi-Fi and/or a short-range communication medium. Some short-range communication mediums, such as NFC, may utilize a separate, dedicated transceiver. Further, in some configurations, a Global Positioning System (GPS) receiver 980 may also make use of the antenna 990 to receive GPS signals. In addition to or instead of the GPS receiver 980, any suitable location-determining sensor may be included and/or used, including, for example, a Wi-Fi positioning system. In some examples, the architecture 900 (e.g., the processor unit 910) may also support a hardware interrupt. In response to a hardware interrupt, the processor unit 910 may pause its processing and execute an interrupt service routine (ISR).

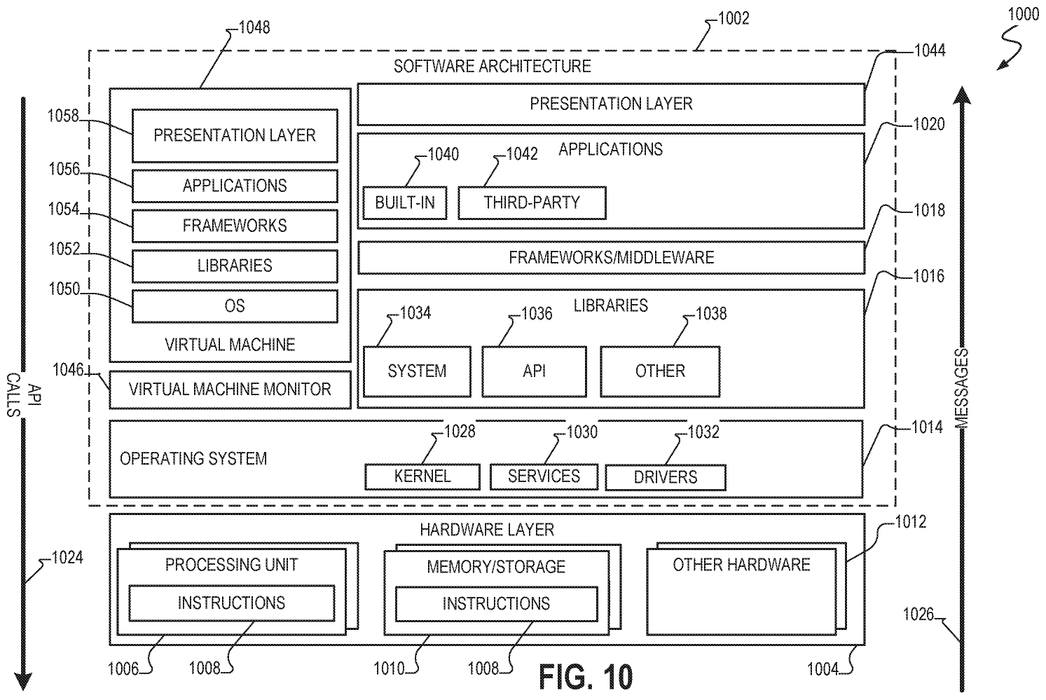

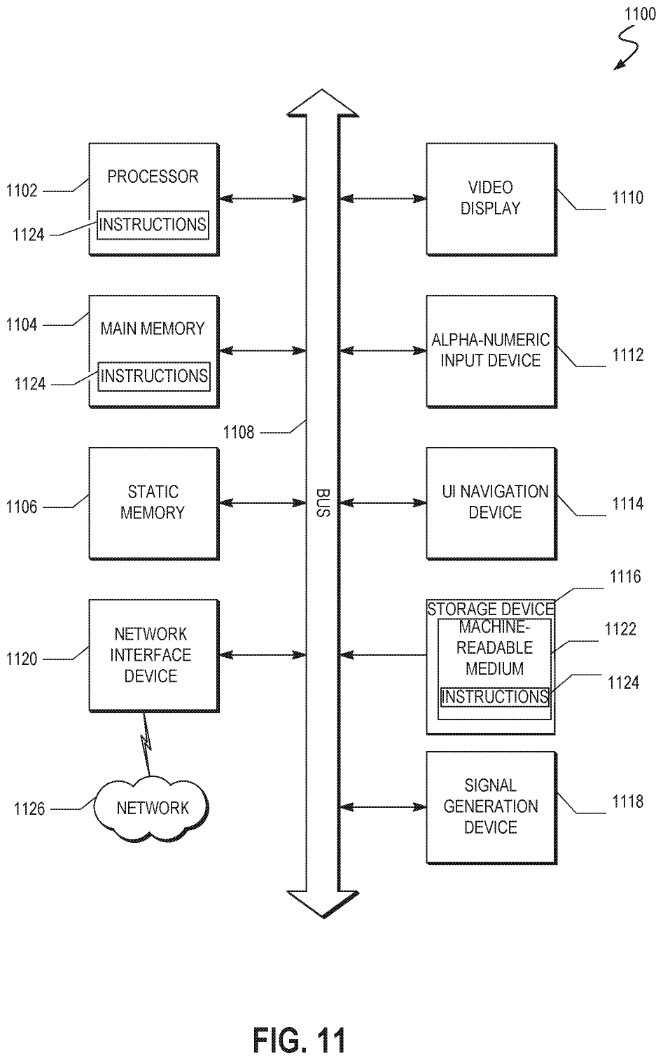

FIG. 10 is a block diagram 1000 showing one example of a software architecture 1002 for a computing device. The software architecture 1002 may be used in conjunction with various hardware architectures, for example, as described herein. FIG. 10 is merely a non-limiting example of a software architecture 1002, and many other architectures may be implemented to facilitate the functionality described herein. A representative hardware layer 1004 is illustrated and can represent, for example, any of the above-referenced computing devices. In some examples, the hardware layer 1004 may be implemented according to an architecture 1100 of FIG. 11 and/or the architecture 900 of FIG. 9.

The representative hardware layer 1004 comprises one or more processing units 1006 having associated executable instructions 1008. The executable instructions 1008 represent the executable instructions of the software architecture 1002, including implementation of the methods, modules, components, and so forth of FIGS. 1-9. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the architecture 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke application programming interface (API) calls 1024 through the software stack and receive a response, returned values, and so forth illustrated as messages 1026 in response to the API calls 1024. The layers illustrated are representative in nature and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of a hardware or software interrupt and, in response, cause the software architecture 1002 to pause its current processing and execute an ISR when an interrupt is received. The ISR may generate an alert.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, and/or drivers 1032). The libraries 1016 may include system libraries 1034 (e.g., C standard library) that may provide functions such as memory allocation functions, string manipulation functions, mathematical functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphical user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. The third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1042 may invoke the API calls 1024 provided by the mobile operating system such as the operating system 1014 to facilitate functionality described herein.

The applications 1020 may utilize built-in operating system functions (e.g., kernel 1028, services 1030, and/or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 10, this is illustrated by a virtual machine 1048. A virtual machine creates a software environment where applications/modules can execute as if they were executing on a hardware computing device. The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, and/or a presentation layer 1058. These layers of software architecture executing within the virtual machine 1048 can be the same as corresponding layers previously described or may be different.

FIG. 11 is a block diagram illustrating a computing device hardware architecture 1100, within which a set or sequence of instructions can be executed to cause a machine to perform examples of any one of the methodologies discussed herein. The architecture 1100 may describe, for example, any of the computing devices and/or control circuits described herein. The architecture 1100 may execute the software architecture 1002 described with respect to FIG. 10. The architecture 1100 may operate as a standalone device or may be connected (e.g., networked) to other machines. In a networked deployment, the architecture 1100 may operate in the capacity of either a server or a client machine in server-client network environments, or it may act as a peer machine in peer-to-peer (or distributed) network environments. The architecture 1100 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1100 includes a processor unit 1102 comprising at least one processor (e.g., a central processing unit (CPU), a graphics processing unit (GPU), or both, processor cores, compute nodes, etc.). The architecture 1100 may further comprise a main memory 1104 and a static memory 1106, which communicate with each other via a link 1108 (e.g., a bus). The architecture 1100 can further include a video display unit 1110, an alphanumeric input device 1112 (e.g., a keyboard), and a UI navigation device 1114 (e.g., a mouse). In some examples, the video display unit 1110, alphanumeric input device 1112, and UI navigation device 1114 are incorporated into a touchscreen display. The architecture 1100 may additionally include a storage device 1116 (e.g., a drive unit), a signal generation device 1118 (e.g., a speaker), a network interface device 1120, and one or more sensors (not shown), such as a GPS sensor, compass, accelerometer, or other sensor.

In some examples, the processor unit 1102 or another suitable hardware component may support a hardware interrupt. In response to a hardware interrupt, the processor unit 1102 may pause its processing and execute an ISR, for example, as described herein.

The storage device 1116 includes a machine-readable medium 1122 on which is stored one or more sets of data structures and instructions 1124 (e.g., software) embodying or utilized by any one or more of the methodologies or functions described herein. The instructions 1124 can also reside, completely or at least partially, within the main memory 1104, within the static memory 1106, and/or within the processor unit 1102 during execution thereof by the architecture 1100, with the main memory 1104, the static memory 1106, and the processor unit 1102 also constituting machine-readable media. The instructions 1124 stored at the machine-readable medium 1122 may include, for example, instructions for implementing the software architecture 1002, instructions for executing any of the features described herein, etc.

While the machine-readable medium 1122 is illustrated in an example to be a single medium, the term “machine-readable medium” can include a single medium or multiple media (e.g., a centralized or distributed database, and/or associated caches and servers) that store the one or more instructions 1124. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1124 can further be transmitted or received over a communications network 1126 using a transmission medium via the network interface device 1120 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein may be machine or computer-implemented at least in part. Some examples may include a computer-readable medium, non-transitory computer-readable medium, or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

Each of these non-limiting examples can stand on its own or can be combined in various permutations or combinations with one or more of the other examples. The following examples detail certain aspects of the present subject matter to solve the challenges and provide the benefits discussed herein.

Example 1 can include a system of interfacing a computing system to a user, the system comprising: at least one processor; and a machine-readable medium comprising instructions thereon that, when executed by the at least one processor, cause the at least one processor to perform operations comprising: receiving at least one first data corresponding to financial inflow data of the user; receiving at least one second data corresponding to financial outflow data of the user; calculating a financial indicator score based at least in part on a difference between the at least one first data and the at least one second data; generating a financial indicator object representing a visual depiction of the financial indicator score, the financial indicator object indicating an overall net financial status including at least one of a net-zero indicator, a net-positive indicator, or a net-negative indicator; and causing a graphical user interface to be displayed to the user, the graphical user interface including the financial indicator object.

In Example 2, the subject matter of Example 1 optionally includes wherein the machine-readable medium further includes the instructions thereon that, when executed by the at least one processor, cause the at least one processor to perform the operations comprising: generating, by the at least one processor, the financial indicator object based, at least in part, on the financial indicator score according to a user-selected time period.

In Example 3, the subject matter of any one of Examples 1-2 optionally include wherein the machine-readable medium further includes the instructions thereon that, when executed by the at least one processor, cause the at least one processor to perform the operations comprising: identifying one or more financial services activities associated with the financial inflow data; calculating an inflow-activities score based on the one or more financial services activities associated with the financial inflow data; identifying one or more financial services activities associated with the financial outflow data; calculating an outflow-activities score based on the one or more financial services activities associated with the financial outflow data; and recalculating the financial indicator score based, at least in part, on the difference between the at least one first data and the at least one second data, the inflow-activities score, and the outflow-activities score.

In Example 4, the subject matter of any one of Examples 1-3 optionally include wherein the machine-readable medium further includes the instructions thereon that, when executed by the at least one processor, cause the at least one processor to perform the operations comprising: dynamically adjusting, in response to the overall net financial status, one or more visual attributes of the graphical user interface.

In Example 5, the subject matter of any one of Examples 1˜4 optionally include wherein the machine-readable medium further includes the instructions thereon that, when executed by the at least one processor, cause the at least one processor to perform the operations comprising: identifying financial health information, wherein the financial health information includes a known tax status amount or an estimated tax status amount; recalculating the financial indicator score based on the financial health information; and generating a second financial indicator object including the financial health information for display on the graphical user interface.

In Example 6, the subject matter of Example 5 optionally includes wherein the machine-readable medium further includes the instructions thereon that, when executed by the at least one processor, cause the at least one processor to perform the operations comprising: providing, to the user, a recommendation of one or more financial advisory services, in response to the financial indicator object being the net-negative indicator.

In Example 7, the subject matter of any one of Examples 1-6 optionally include wherein the at least one first data corresponding to the financial inflow data, the at least one second data corresponding to the financial outflow data, or both the at least one first data and the at least one second data are received from an internal source to the computing system, the computing system including a bank.

In Example 8, the subject matter of any one of Examples 1-7 optionally include wherein a subset of the at least one first data, a subset of the at least one second data, or both the subset of the at least one first data and the subset of the at least one second data are received from an external source from the computing system.

Example 9 is a method of interfacing a computing system to a user, the method comprising: receiving, by at least one hardware processor, at least one first data corresponding to financial inflow data of the user; receiving at least one second data corresponding to financial outflow data of the user; calculating a financial indicator score based at least in part on a difference between the at least one first data and the at least one second data; generating a financial indicator object representing a visual depiction of the financial indicator score, the financial indicator object indicating an overall net financial status including at least one of a net-zero indicator, a net-positive indicator, or a net-negative indicator; and causing a graphical user interface to be displayed to the user, the graphical user interface including the financial indicator object.

In Example 10, the subject matter of Example 9 optionally includes further comprising: generating, by the at least one hardware processor, the financial indicator object based, at least in part, on the financial indicator score according to a user-selected time period.

In Example 11, the subject matter of any one of Examples 9-10 optionally include further comprising: identifying one or more financial services activities associated with the financial inflow data; calculating an inflow-activities score based on the one or more financial services activities associated with the financial inflow data; identifying one or more financial services activities associated with the financial outflow data; calculating an outflow-activities score based on the one or more financial services activities associated with the financial outflow data; and recalculating the financial indicator score based, at least in part, on the difference between the at least one first data and the at least one second data, the inflow-activities score, and the outflow-activities score.

In Example 12, the subject matter of any one of Examples 9-11 optionally include further comprising: dynamically adjusting, in response to the overall net financial status, one or more visual attributes of the graphical user interface.

In Example 13, the subject matter of Example 12 optionally includes further comprising: dynamically adjusting, in response to the overall net financial status, one or more visual attributes of the graphical user interface.

In Example 14, the subject matter of Example 12 optionally includes further comprising: providing, to the user, a recommendation of one or more financial advisory services, in response to the financial indicator object being the net-negative indicator.

In Example 15, the subject matter of any one of Examples 9-14 optionally include wherein the at least one first data corresponding to the financial inflow data, the at least one second data corresponding to the financial outflow data, or both the at least one first data and the at least one second data are received from an internal source to the computing system.

In Example 16, the subject matter of any one of Examples 9-15 optionally include wherein a subset of the at least one first data, a subset of the at least one second data, or both the subset of the at least one first data and the subset of the at least one second data are received from an external source from the computing system.

Example 17 is a non-transitory machine-readable storage device having instructions thereon that, when executed by at least one processor, cause the at least one processor to perform operations comprising: receiving at least one first data corresponding to financial inflow data of a user; receiving at least one second data corresponding to financial outflow data of the user; calculating a financial indicator score based at least in part on a difference between the at least one first data and the at least one second data; and causing a graphical user interface to be displayed to the user, the graphical user interface including a financial indicator object representing a visual depiction of the financial indicator score.

In Example 18, the subject matter of Example 17 optionally includes wherein the machine-readable storage device further includes the instructions that, when executed by the at least one processor, cause the at least one processor to perform the operations comprising: identifying one or more financial services activities associated with the financial inflow data; calculating an inflow-activities score based on the one or more financial services activities associated with the financial inflow data; identifying one or more financial services activities associated with the financial outflow data; calculating an outflow-activities score based on the one or more financial services activities associated with the financial outflow data; and recalculating the financial indicator score based, at least in part, on the difference between the at least one first data and the at least one second data, the inflow-activities score, and the outflow-activities score.

In Example 19, the subject matter of any one of Examples 17-18 optionally include wherein the machine-readable storage device further includes the instructions that, when executed by the at least one processor, cause the at least one processor to perform the operations comprising: wherein the financial indicator object indicates an overall net financial status including at least one of a net-zero indicator, a net-positive indicator, or a net-negative indicator; and dynamically adjust, in response to the overall net financial status, one or more visual attributes of the graphical user interface.

In Example 20, the subject matter of any one of Examples 17-19 optionally include wherein the machine-readable storage device further includes the instructions that, when executed by the at least one processor, cause the at least one processor to perform the operations comprising: providing, to the user, a recommendation of one or more financial advisory services, in response to the financial indicator object being the net-negative indicator.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system of interfacing a computing system to a user, the system comprising:
at least one processor; and
a machine-readable medium comprising instructions thereon that, when executed by the at least one processor, cause the at least one processor to perform operations comprising:
receiving at least one first data corresponding to financial inflow data of the user;
receiving at least one second data corresponding to financial outflow data of the user;
calculating a financial indicator score based at least in part on a difference between the at least one first data and the at least one second data;
generating a financial indicator object representing a visual depiction of the financial indicator score, the financial indicator object indicating an overall net financial status including at least one of a net-zero indicator, a net-positive indicator, or a net-negative indicator; and
causing a graphical user interface to be displayed to the user, the graphical user interface including the financial indicator object.

2. The system of claim 1, wherein the machine-readable medium further includes the instructions thereon that, when executed by the at least one processor, cause the at least one processor to perform the operations comprising:
generating, by the at least one processor, the financial indicator object based, at least in part, on the financial indicator score according to a user-selected time period.

3. The system of claim 1, wherein the machine-readable medium further includes the instructions thereon that, when executed by the at least one processor, cause the at least one processor to perform the operations comprising:
identifying one or more financial services activities associated with the financial inflow data;
calculating an inflow-activities score based on the one or more financial services activities associated with the financial inflow data;
identifying one or more financial services activities associated with the financial outflow data;
calculating an outflow-activities score based on the one or more financial services activities associated with the financial outflow data; and
recalculating the financial indicator score based, at least in part, on the difference between the at least one first data and the at least one second data, the inflow-activities score, and the outflow-activities score.

4. The system of claim 1, wherein the machine-readable medium further includes the instructions thereon that, when executed by the at least one processor, cause the at least one processor to perform the operations comprising:
dynamically adjusting, in response to the overall net financial status, one or more visual attributes of the graphical user interface.

5. The system of claim 1, wherein the machine-readable medium further includes the instructions thereon that, when executed by the at least one processor, cause the at least one processor to perform the operations comprising:
identifying financial health information, wherein the financial health information includes a known tax status amount or an estimated tax status amount;
recalculating the financial indicator score based on the financial health information; and
generating a second financial indicator object including the financial health information for display on the graphical user interface.

6. The system of claim 4, wherein the machine-readable medium further includes the instructions thereon that, when executed by the at least one processor, cause the at least one processor to perform the operations comprising:
providing, to the user, a recommendation of one or more financial advisory services, in response to the financial indicator object being the net-negative indicator.

7. The system of claim 1, wherein the at least one first data corresponding to the financial inflow data, the at least one second data corresponding to the financial outflow data, or both the at least one first data and the at least one second data are received from an internal source to the computing system, the computing system including a bank.

8. The system of claim 1, wherein a subset of the at least one first data, a subset of the at least one second data, or both the subset of the at least one first data and the subset of the at least one second data are received from an external source from the computing system.

9. A method of interfacing a computing system to a user, the method comprising:
receiving, by at least one hardware processor, at least one first data corresponding to financial inflow data of the user;
receiving at least one second data corresponding to financial outflow data of the user;
calculating a financial indicator score based at least in part on a difference between the at least one first data and the at least one second data;
generating a financial indicator object representing a visual depiction of the financial indicator score, the financial indicator object indicating an overall net financial status including at least one of a net-zero indicator, a net-positive indicator, or a net-negative indicator; and
causing a graphical user interface to be displayed to the user, the graphical user interface including the financial indicator object.

10. The method of claim 9, further comprising:
generating, by the at least one hardware processor, the financial indicator object based, at least in part, on the financial indicator score according to a user-selected time period.

11. The method of claim 9, further comprising:
identifying one or more financial services activities associated with the financial inflow data;
calculating an inflow-activities score based on the one or more financial services activities associated with the financial inflow data;
identifying one or more financial services activities associated with the financial outflow data;
calculating an outflow-activities score based on the one or more financial services activities associated with the financial outflow data; and
recalculating the financial indicator score based, at least in part, on the difference between the at least one first data and the at least one second data, the inflow-activities score, and the outflow-activities score.

12. The method of claim 9, further comprising:
dynamically adjusting, in response to the overall net financial status, one or more visual attributes of the graphical user interface.

13. The method of claim 12, further comprising:
dynamically adjusting, in response to the overall net financial status, one or more visual attributes of the graphical user interface.

14. The method of claim 12, further comprising:
providing, to the user, a recommendation of one or more financial advisory services, in response to the financial indicator object being the net-negative indicator.

15. The method of claim 9, wherein the at least one first data corresponding to the financial inflow data, the at least one second data corresponding to the financial outflow data, or both the at least one first data and the at least one second data are received from an internal source to the computing system.

16. The method of claim 9, wherein a subset of the at least one first data, a subset of the at least one second data, or both the subset of the at least one first data and the subset of the at least one second data are received from an external source from the computing system.

17. A non-transitory machine-readable storage device having instructions thereon that, when executed by at least one processor, cause the at least one processor to perform operations comprising:
receiving at least one first data corresponding to financial inflow data of a user;
receiving at least one second data corresponding to financial outflow data of the user;
calculating a financial indicator score based at least in part on a difference between the at least one first data and the at least one second data; and
causing a graphical user interface to be displayed to the user, the graphical user interface including a financial indicator object representing a visual depiction of the financial indicator score.

18. The machine-readable storage device of claim 17, wherein the machine-readable storage device further includes the instructions that, when executed by the at least one processor, cause the at least one processor to perform the operations comprising:
identifying one or more financial services activities associated with the financial inflow data;
calculating an inflow-activities score based on the one or more financial services activities associated with the financial inflow data;
identifying one or more financial services activities associated with the financial outflow data;
calculating an outflow-activities score based on the one or more financial services activities associated with the financial outflow data; and
recalculating the financial indicator score based, at least in part, on the difference between the at least one first data and the at least one second data, the inflow-activities score, and the outflow-activities score.

19. The machine-readable storage device of claim 17, wherein the machine-readable storage device further includes the instructions that, when executed by the at least one processor, cause the at least one processor to perform the operations comprising:
wherein the financial indicator object indicates an overall net financial status including at least one of a net-zero indicator, a net-positive indicator, or a net-negative indicator; and
dynamically adjust, in response to the overall net financial status, one or more visual attributes of the graphical user interface.

20. The machine-readable storage device of claim 17, wherein the machine-readable storage device further includes the instructions that, when executed by the at least one processor, cause the at least one processor to perform the operations comprising:
providing, to the user, a recommendation of one or more financial advisory services, in response to the financial indicator object being the net-negative indicator.
